(19) United States
(12) Patent Application Publication
(10) Pub. No.: US 2012/0295628 A1
(43) Pub. Date: Nov. 22, 2012

(54) Mobile Terminal Device And Control Method Thereof

(75) Inventors: Hiroshi TAKEDA, Kanagawa (JP); Hideyuki HOSHINO, Kanagawa (JP)

(73) Assignee: KYOCERA CORPORATION, Kyoto (JP)

(21) Appl. No.: 13/475,100

(22) Filed: May 18, 2012

(30) Foreign Application Priority Data
May 19, 2011 (JP) 2011-112450

(51) Int. Cl. H04W 72/04; H04W 88/02

(52) U.S. Cl. 455/450

(57) ABSTRACT

A cellular telephone device includes: an external connection unit that communicates with a PC; a wireless communication unit that wirelessly communicates with a base station; and a control unit that controls the external connection unit to send data received by the wireless communication unit to the PC or controls the wireless communication unit to send data received by the external connection unit to the base station, in which the control unit controls the wireless communication unit to send information relating to resource assignment corresponding to a data transfer rate of the external connection unit to the base station.

This application is based on and claims the benefit of priority from Japanese Patent Application No. 2011-112450, filed on 19 May 2011, the content of which is incorporated herein by reference.

### BACKGROUND OF THE INVENTION

1. Field of the Invention

The present invention relates to a mobile terminal device that controls data transfer and a control method thereof.

2. Related Art

High speed data communication protocols such as WiMAX (Worldwide Interoperability for Microwave Access), LTE (Long Term Evolution) and the like are conventionally widely used in a mobile terminal device with a data communication function. For example, for LTE, control of transmission cycle of wireless resource assignment requests has been proposed (for example, see Japanese Unexamined Patent Application, Publication No. 2009-296537).

In addition, for a wireless communication module connected to an information processing device via two buses with different transfer rates, switching between these buses has been proposed (for example, see Japanese Unexamined Patent Application, Publication No. 2006-211486).

### SUMMARY OF THE INVENTION

The present invention is aimed at providing a mobile terminal device and a control method thereof allowing efficient use of wireless resources.

A mobile terminal device according to the present invention includes: a first communication unit that communicates with an external device; a second communication unit that wirelessly communicates with a base station; and a control unit that controls the first communication unit to send data received by the second communication unit to the external device or controls the second communication unit to send data received by the first communication unit to the base station, in which the control unit controls the second communication unit to send information relating to resource assignment corresponding to a data transfer rate of the first communication unit to the base station.

It is preferable that the control unit controls the second communication unit to send the information relating to resource assignment corresponding to a data transfer rate of the first communication unit to the base station in a case in which the data transfer rate of the first communication unit is lower than a data transfer rate of the second communication unit.

It is preferable that, in receiving data from the base station, the control unit controls the second communication unit to send the information relating to resource assignment along with a CQI report.

It is preferable that, in sending data to the base station, the control unit controls the second communication unit to send the information relating to resource assignment along with a scheduling request.

It is preferable that the control unit includes information specifying at least one of: the number of MIMO channels; a multiple value number of modulation system; and a frequency bandwidth, to the base station, as the information relating to resource assignment.

It is preferable that a theoretical value of the data transfer rate of the second communication unit is determined based on a combination of parameter values: the number of MIMO channels; a multiple value number of modulation system; and a frequency bandwidth.

It is preferable that the control unit determines the parameter values of the combination in an order of: the number of MIMO channels; the multiple value number of modulation system; and the frequency bandwidth.

It is preferable that the control unit changes the order to: the number of MIMO channels; the frequency bandwidth; and the multiple value number of modulation system, in a case in which wireless communication quality of the second communication unit does not reach a predetermined level.

It is preferable that the control unit controls the second communication unit to send new information relating to resource assignment to the base station, in a case in which data transfer rate of the second communication unit becomes lower than the data transfer rate of the first communication unit after assignment of a predetermined resource to a terminal in response to the information relating to resource assignment being sent.

It is preferable that the control unit defines the new information relating to resource assignment by incrementing the multiple value number of modulation system in the information relating to resource assignment.

It is preferable that the control unit specifies information relating to data transfer rate of the first communication unit that corresponds to at least one of: the number of MIMO channels; the multiple value number of modulation system; and the frequency bandwidth, in the base station, as the information relating to resource assignment.

It is preferable that the information relating to resource assignment includes a communication system of the first communication unit.

A control method according to the present invention by which a mobile terminal device including a first communication unit that communicates with an external device and a second communication unit that wirelessly communicates with a base station controls the first communication unit to send data received by the second communication unit to the external device or controls the second communication unit to send data received by the first communication unit to the base station, includes a step of controlling the second communication unit to send information relating to resource assignment corresponding to a data transfer rate of the first communication unit to the base station.

According to the present invention, a mobile terminal device can use wireless resources efficiently.

### BRIEF DESCRIPTION OF THE DRAWINGS

FIG. 1 is a perspective view showing an appearance of a cellular telephone device according to an embodiment of the present invention;

FIG. 2 is a block diagram showing features of the cellular telephone device according to the embodiment of the present invention;

FIG. 3 is a sequence diagram showing resource assignment of a downstream link according to the embodiment of the present invention;

FIG. 4 is a sequence diagram showing resource assignment of an upstream link according to the embodiment of the present invention;

FIG. 5 is a diagram showing a parameter table according to the embodiment of the present invention;

FIG. 6 is a flow chart showing a process of determining a parameter relating to resource assignment according to the embodiment of the present invention; and

FIG. 7 is a flow chart showing a process of adjusting a parameter after resource assignment according to the embodiment of the present invention.

### DETAILED DESCRIPTION OF THE INVENTION

An embodiment of the present invention is described hereinafter. In the present embodiment, a cellular telephone device 1 is described as an example of the mobile terminal device.

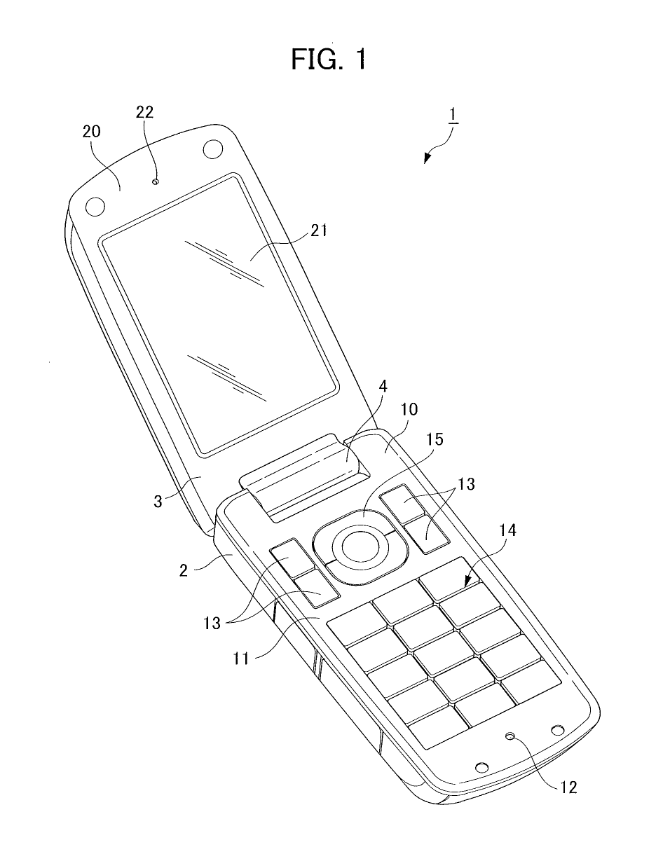

FIG. 1 is a perspective view showing an appearance of the cellular telephone device 1 according to the present embodiment.

It should be noted that, although FIG. 1 shows a so-called flip type cellular telephone device, the present invention is not limited thereto. The cellular telephone device 1 may be of, for example: a slider type in which one body slides to one direction from a state in which two bodies are mutually superimposed; a rotating type (turning type) in which one body is rotated about an axis line along the direction in which two bodies are superimposed; or a type in which an operation unit and a display unit are arranged in one body without a connection unit (straight type).

The cellular telephone device 1 is configured to include an operation unit side body 2 and a display unit side body 3. The operation unit side body 2 is configured to include on a front face 10 thereof an operation unit 11 and a microphone 12 to which sounds, which a user of the cellular telephone 1 produces during a phone call and during use of a speech recognition application, are input. The operation unit 11 is composed of: feature setting operation buttons 13 for operating various settings and various features such as a telephone number directory feature and a mail feature; input operation buttons 14 for inputting digits of a telephone number and characters for mail; and a selection operation button 15 that performs selection of the various operations and scrolling.

In addition, the display unit side body 3 is configured to include, on a front face portion 20, a display unit 21 for displaying a variety of information, and a receiver 22 for outputting sound of the other party of the conversation.

An upper end portion of the operation unit side body 2 and a lower end portion of the display unit side body 3 are connected via a hinge mechanism 4. The cellular telephone device 1 can be in a state where the operation unit side body 2 and the display unit side body 3 are apart from each other (opened state), or in a state where the operation unit side body 2 and the display unit side body 3 are contacting each other (closed state), as the operation unit side body 2 and the display unit side body 3, connected via the hinge mechanism 4, pivot with respect to each other.

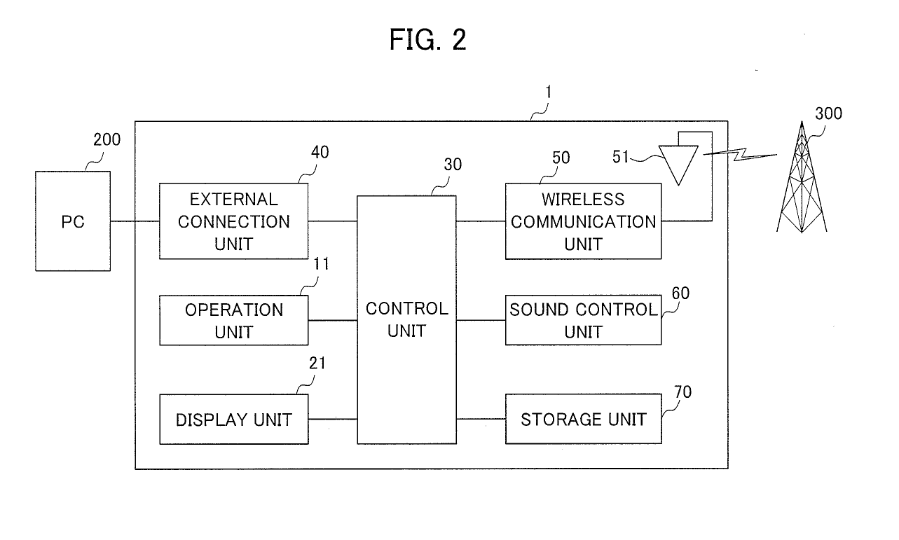

FIG. 2 is a block diagram showing features of the cellular telephone device 1 according to the present embodiment.

The cellular telephone device 1 is provided with: an operation unit 11; a display unit 21; a control unit 30; an external connection unit 40 (the first communication unit); a wireless communication unit 50 (the second communication unit); a sound control unit 60; and a storage unit 70. Although a PC 200 is exemplified as an external device connected to the cellular telephone device 1; however, the external device can also be various information processing devices and memory devices with an interface such as USB.

The control unit 30 controls the entire cellular telephone device 1 and performs predetermined control with respect to the display unit 21, the external connection unit 40, the wireless communication unit 50 and the like. The control unit 30 also accepts input from the operation unit 11, the external connection unit 40, the wireless communication unit 50 and the like and performs various processes. During performing of the processes, the control unit 30 reads various programs and data, and writes data by controlling the storage unit 70.

More specifically, the control unit 30 controls the external connection unit 40 to send data received by the wireless communication unit 50 to the PC 200, or controls the wireless communication unit 50 to send data received by the external connection unit 40 to a base station 300. Here, the control unit 30 performs processing (described later) for generating information relating to wireless resource assignment and sending to the base station 300. In addition, the base station 300 assigns wireless resource to the cellular telephone device 1 based on information sent from the cellular telephone device 1.

The external connection unit 40 is an interface device that is connected to the PC 200 and establishes data communication with the PC 200 by a predetermined communication protocol. For example, USB 1.0 is used as the communication protocol and 12 Mbps is expected as a data transfer rate thereof.

The wireless communication unit 50 establishes communication with the base station 300 by a predetermined usable frequency band (for example, 2 GHz band, 1.5 GHz band and the like). The wireless communication unit 50 then performs demodulation processing of a signal received by the antenna 51, supplies the processed signal to the control unit 30, performs modulation processing of a signal supplied from the control unit 30, and submits the processed signal to the base station 300 via the antenna 51.

In the present embodiment, the wireless communication unit 50 supports: communication protocols for sound and data communication, W-CDMA/CDMA2000_{—}1x; and a communication protocol mainly for high speed data communication, LTE, and can establish communication by any of these protocols. The wireless communication unit 50 establishes communication with the base station 300 by any one of these protocols, based on an instruction from the control unit 30. The cellular telephone device 1 establishes communication by the CDMA system for voice communication; and preferentially by the LTE system for data communication.

The sound control unit 60 performs predetermined sound processing with respect to the signal supplied from the wireless communication unit 50 according to control by the control unit 30, and outputs the signal thus processed to the receiver 22. The receiver 22 outputs the signal supplied from the sound control unit 60 to the outside. The signal can also be output from a speaker (not illustrated) instead of, or along with, the receiver 22. In addition, the sound control unit 60 processes the signal being input from the microphone 12 according to control by the control unit 30 and outputs the signal thus processed to the wireless communication unit 50. The wireless communication unit 50 performs predetermined processing with respect to the signal supplied from the sound control unit 60 and outputs the signal thus processed from the antenna.

The storage unit 70 includes, for example, working memory and is used for arithmetic processing by the control unit 30. The storage unit 70 stores various programs according to the present embodiment. In addition, the storage unit 70 stores a parameter table (described later) as information relating to resource assignment corresponding to the data transfer rate.

Functions of the control unit 30 are described later in detail.

The control unit 30 controls the wireless communication unit 50 to send the information relating to resource assignment corresponding to a data transfer rate of the external connection unit 40 to the base station 300, in a case in which the data transfer rate of the external connection unit 40 is lower than a data transfer rate of the wireless communication unit 50. Although not illustrated, a measuring unit can be provided for measuring the data transfer rate.

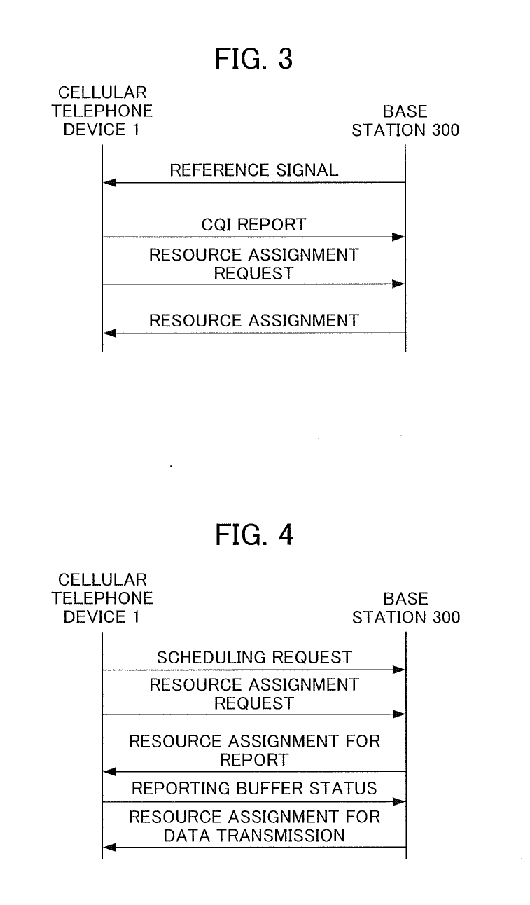

FIG. 3 is a sequence diagram showing resource assignment of a downstream link in the cellular telephone device 1 according to the present embodiment.

In receiving data from the base station 300, the control unit 30 first measures receiving status of a reference signal sent from the base station 300 and sends a CQI (Channel Quality Indicator) report, which is defined in 3GPP, to the base station 300.

Here, the control unit 30 also controls the wireless communication unit 50 to send information relating to resource assignment. The information relating to resource assignment includes information specifying at least one of: the number of MIMO channels (1×1, 2×2, 4×4); a multiple value number of modulation system (QPSK, 16QAM, 64QAM); and a frequency bandwidth (1.25 MHz, 3 MHz, 5 MHz, 10 MHz, 15 MHz, 20 MHz), to the base station 300.

The data transfer rate of the wireless communication unit 50 is determined by the base station 300 based on a combination of the number of MIMO channels, the multiple value number of modulation system, and the frequency bandwidth. The base station 300 then assigns a wireless resource to the cellular telephone device 1 by resource blocks (RB), which is defined in 3GPP, based on the CQI thus reported, communication service quality, a sending buffer content status in the base station 300, and the like.

After assigning the resource to the cellular telephone device 1, the base station 300 notifies resource assignment information (the resource blocks thus assigned and the like) and a transport format (the number of MIMO channels, the modulation system, a code rate and the like) to the cellular telephone device 1.

FIG. 4 is a sequence diagram showing resource assignment of an upstream link in the cellular telephone device 1 according to the present embodiment.

In sending data to the base station 300, the control unit 30 sends a scheduling request, which is defined in 3GPP, to the base station 300.

Here, the control unit 30 also controls the wireless communication unit 50 to send information relating to resource assignment. The information relating to resource assignment includes information specifying at least one of: the number of MIMO channels; a multiple value number of modulation system; and a frequency bandwidth, to the base station 300, as in the case of the downstream link.

After receiving the scheduling request, the base station 300 assigns a predetermined initial resource and receives a report of buffer status from the cellular'telephone device 1.

The data transfer rate of the wireless communication unit 50 is determined by the base station 300 based on a combination of the number of MIMO channels, the multiple value number of modulation system, and the frequency bandwidth. Thereafter, the base station 300 assigns a wireless resource to the cellular telephone device 1 by resource blocks, based on the buffer status thus reported, a channel status periodically notified from the cellular telephone 1, and the like.

After assigning the resource to the cellular telephone device 1, the base station 300 notifies resource assignment information (the resource blocks thus assigned and the like) and a transport format (the number of MIMO channels, the modulation system, a code rate and the like) to the cellular telephone device 1.

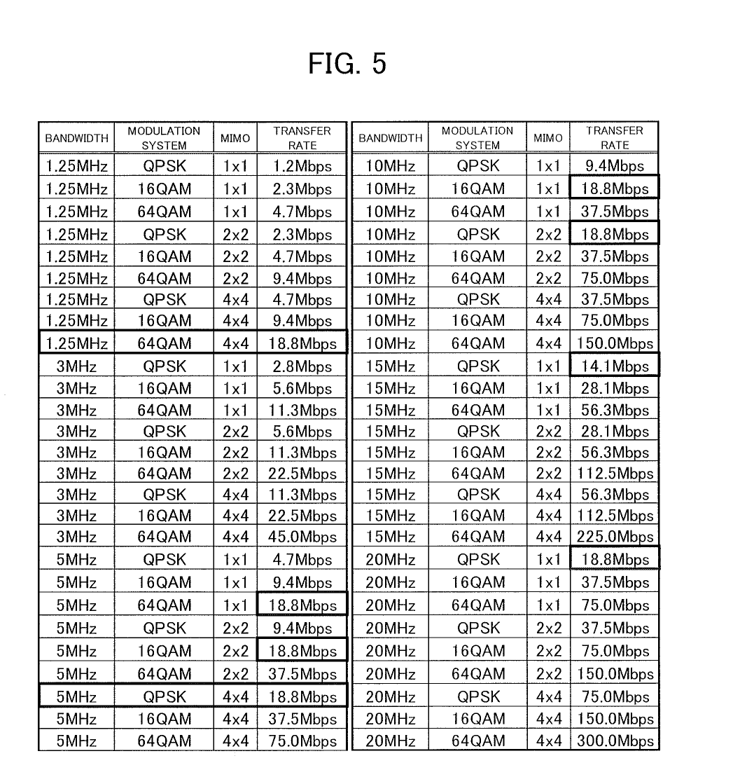

FIG. 5 is a diagram showing a parameter table according to the present embodiment.

In the parameter table, combinations of parameters relating to resource assignment and the data transfer rates corresponding to each other are recorded.

For example, in a case in which the frequency bandwidth is 1.25 MHz, the modulation system is 64 QAM, and the MIMO is 4×4, the data transfer rate of the wireless communication unit 50 is expected to be 18.8 Mbps. The data transfer rate is a theoretical estimated value and an actual data transfer rate is affected by external factors.

The control unit 30 refers to the parameter table and determines, as the information relating to resource assignment, maximum possible values among the combinations of parameters, in an order of: the number of MIMO channels, the multiple value number of modulation system, and the frequency bandwidth.

For example, given that the interface of the external connection unit 40 is USB 1.0 and the data transfer rate is 12 Mbps, the control unit 30 extracts a combination that provides a data transfer rate of a particular range, which is higher than the abovementioned data transfer rate. More specifically, combinations that provide a data transfer rate of 14.1 Mbps or 18.8 Mbps are extracted.

Thereafter, from the combination thus extracted, the control unit 30 selects combinations with the greatest number of MIMO channel (4×4) and then, from the combination thus selected, the control unit 30 selects combinations with the greatest multiple value number of modulation system (64QAM). As a result, a combination with the frequency bandwidth of 1.25 MHz, the modulation system of 64QAM, and MIMO of 4×4 is determined.

By determining the parameters in this order, the frequency bandwidth is set to be as narrow as possible, to thereby efficiently use the wireless resource.

In addition, the control unit 30 changes the order to: the number of MIMO channels; the frequency bandwidth; and the multiple value number of modulation system, in a case in which wireless communication quality of the wireless communication unit 50 does not reach a predetermined level. In other words, the control unit 30 can thus reduce the error rate while maintaining the data transfer rate by widening the frequency bandwidth and reducing the multiple value number of the modulation system.

Furthermore, the control unit 30 controls the wireless communication unit 50 to send new information relating to resource assignment to the base station 300, in a case in which data transfer rate of the wireless communication unit 50 becomes lower than the data transfer rate of the external connection unit 40 after assignment of the resource to the wireless communication unit 50 in response to the information relating to resource assignment being sent.

More specifically, the control unit 30 defines the new information relating to resource assignment by incrementing the multiple value number of modulation system in the current information relating to resource assignment. In other words, in a case in which there is a delay in communication with the base station 300, the control unit 30 changes the parameter to increase the data transfer rate. Here, data communication must be interrupted for changing the MIMO or the frequency bandwidth. The control unit 30 therefore changes the modulation system, which can be specified for each frame, for maintaining the data communication.

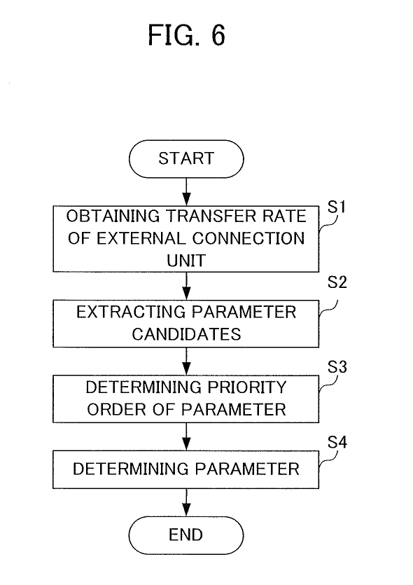

FIG. 6 is a flow chart showing a process of determining parameters relating to resource assignment based on the data transfer rate of the external connection unit 40 according to the present embodiment.

In Step S1, the control unit 30 obtains the data transfer rate of the external connection unit 40 with respect to the PC 200.

In Step S2, the control unit 30 extracts candidate parameter combinations with data transfer rates greater than the data transfer rate obtained in Step S1 and within a predetermined range of data transfer rate, from the parameter table.

In Step S3, the control unit 30 determines a priority order of the parameters (the number of MIMO channels, the multiple value number of modulation system, and the frequency bandwidth) according to communication quality (for example, signal status) of the wireless communication unit 50.

In Step S4, the control unit 30 determines a combination among the candidate parameter combinations extracted in Step S2 according to the priority order determined in Step S3.

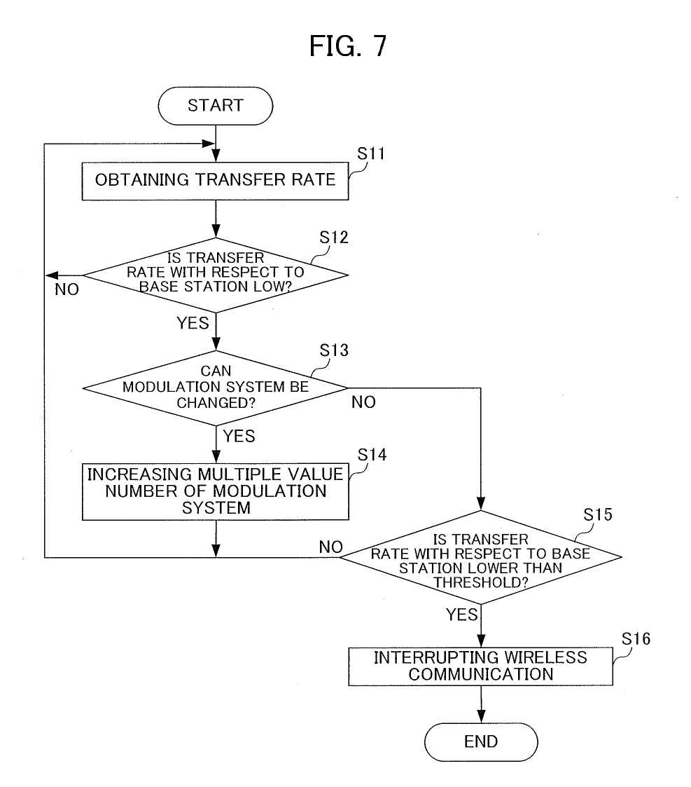

FIG. 7 is a flow chart showing a process of adjusting the parameters after resource assignment according to the present embodiment.

In Step S11, the control unit 30 obtains the data transfer rate of the external connection unit 40 with respect to the PC 200 and the data transfer rate of the wireless communication unit 50 with respect to the base station 300.

In Step S12, the control unit 30 determines whether the data transfer rate of the wireless communication unit 50 with respect to the base station 300 is lower than the data transfer rate of the external connection unit 40 with respect to the PC 200. If a result of the determination is YES, the data transfer rate of the wireless communication unit 50 needs to be improved, and the processing is advanced to Step S13. On the other hand, if a result of the determination is NO, adjustment of the data transfer rate is not necessary, and the processing is advanced to Step S11.

In Step S13, the control unit 30 determines whether the multiple value number can be increased by changing the current modulation system. If a result of the determination is YES, the processing is advanced to Step S14; and if NO, the processing is advanced to Step S15.

In Step S14, the control unit 30 notifies the parameters with the multiple value number of modulation system being incremented (for example, from QPSK to 16QAM or 16QAM to 64QAM), as the new information relating to resource assignment, to the base station 300.

In Step S15, the control unit 30 determines whether a state in which the data transfer rate of the wireless communication unit 50 with respect to the base station 300 has been lower than a predetermined threshold is continuing for a certain period of time. If a result of the determination is YES, the processing is advanced to Step S16; and if NO, the processing is advanced to Step S11.

In Step S16, the control unit 30 disconnects the base station 300, as the communication quality of the wireless communication unit 50 is not sufficient for continuing data communication.

As described above, according to the present embodiment, the cellular telephone device 1 provides the base station 300 with the information relating to resource assignment based on the data transfer rate of the external connection unit 40, to thereby appropriately adjust the data transfer rate of the wireless communication unit 50 and to efficiently use the wireless resource during data transfer in connection with the PC 200.

Here, the cellular telephone device 1 can easily determine a combination of parameters (the number of MIMO channels, the multiple value number of modulation system, and the frequency bandwidth) corresponding in advance to the data transfer rate as the information relating to resource assignment.

In addition, as the cellular telephone device 1 determines maximum possible values among the combination, in an order of: the number of MIMO channels, the multiple value number of modulation system, and the frequency bandwidth, the smallest possible frequency bandwidth can be specified and wireless resource can be efficiently used.

In addition, the cellular telephone device 1 changes the order of determining the parameters to: the number of MIMO channels; the frequency bandwidth; and the multiple value number of modulation system, in a case in which wireless communication quality of the wireless communication unit 50 does not reach a predetermined level. As a result, the cellular telephone device 1 can prevent reduction in data transfer rate by selecting a modulation system with lower error rate.

In addition, in a case in which the data transfer rate of the wireless communication unit 50 becomes lower than the data transfer rate of the external connection unit 40 after assignment of a wireless resource, the cellular telephone device 1 can appropriately adjust the data transfer rate of the wireless communication unit 50 by providing the base station 300 with new information relating to resource assignment for avoiding reduction in entire data transfer rate.

Here, as the cellular telephone device 1 specifies the new information relating to resource assignment by incrementing the multiple value number of modulation system, data communication is not interrupted as in a case of changing the number of MIMO channels or the frequency bandwidth.

Although the embodiment of the present invention has been described above, the present invention is not limited thereto. In addition, the effects described in the embodiment of the present invention are merely examples of desirable effect of the present invention and the effect of the present invention is not limited thereto.

In the above embodiment, at least one of: the number of MIMO channels; the multiple value number of modulation system; and the frequency bandwidth, is determined in the cellular telephone device 1; however, the present invention is not limited thereto. For example, the cellular telephone device 1 can send information relating to data transfer rate of the external connection unit 40 that corresponds to at least one of: the number of MIMO channels; the multiple value number of modulation system; and the frequency bandwidth, in the base station 300. More specifically, the cellular telephone device 1 can send a communication system of the external connection unit 40 (a protocol such as USB 1.0). As a result, management of the parameter table is not necessary in the cellular telephone device 1 and a processing load of the cellular telephone device 1 can be reduced.

In addition, the mobile terminal device of the present invention is not limited to the cellular telephone device 1. For example, the present invention can also be applied to various apparatuses, for example a PHS (trade mark: Personal Handy Phone System), a PDA (Persona Digital Assistant), a gaming machine, a navigation system, a personal computer, a communication module having only a communication function, and the like.

What is claimed is:

1. A mobile terminal device comprising: a first communication unit that communicates with an external device;
a second communication unit that wirelessly communicates with a base station; and
a control unit that controls the first communication unit to send data received by the second communication unit to the external device or controls the second communication unit to send data received by the first communication unit to the base station,
wherein the control unit controls the second communication unit to send information relating to resource assignment corresponding to a data transfer rate of the first communication unit to the base station.

2. The mobile terminal device according to claim 1, wherein the control unit controls the second communication unit to send the information relating to resource assignment corresponding to a data transfer rate of the first communication unit to the base station in a case in which the data transfer rate of the first communication unit is lower than a data transfer rate of the second communication unit.

3. The mobile terminal device according to claim 1, wherein, in receiving data from the base station, the control unit controls the second communication unit to send the information relating to resource assignment along with a CQI report.

4. The mobile terminal device according to claim 1, wherein, in sending data to the base station, the control unit controls the second communication unit to send the information relating to resource assignment along with a scheduling request.

5. The mobile terminal device according to claim 1, wherein the control unit includes information specifying at least one of: the number of MIMO channels; a multiple value number of modulation system; and a frequency bandwidth, to the base station, as the information relating to resource assignment.

6. The mobile terminal device according to claim 5, wherein a theoretical value of the data transfer rate of the second communication unit is determined based on a combination of parameter values: the number of MIMO channels; a multiple value number of modulation system; and a frequency bandwidth.

7. The mobile terminal device according to claim 6, wherein the control unit determines the parameter values of the combination in an order of: the number of MIMO channels; the multiple value number of modulation system; and the frequency bandwidth.

8. The mobile terminal device according to claim 7, wherein the control unit changes the order to: the number of MIMO channels; the frequency bandwidth; and the multiple value number of modulation system, in a case in which wireless communication quality of the second communication unit does not reach a predetermined level.

9. The mobile terminal device according to claim 5, wherein the control unit controls the second communication unit to send new information relating to resource assignment to the base station, in a case in which data transfer rate of the second communication unit becomes lower than the data transfer rate of the first communication unit after assignment of a predetermined resource to a terminal in response to the information relating to resource assignment being sent.

10. The mobile terminal device according to claim 9, wherein the control unit defines the new information relating to resource assignment by incrementing the multiple value number of modulation system in the information relating to resource assignment.

11. The mobile terminal device according to claim 1, wherein the control unit specifies information relating to data transfer rate of the first communication unit that corresponds to at least one of: the number of MIMO channels; the multiple value number of modulation system; and the frequency bandwidth, in the base station, as the information relating to resource assignment.

12. The mobile terminal device according to claim 11, wherein the information relating to resource assignment includes a communication system of the first communication unit.

13. A control method by which a mobile terminal device including a first communication unit that communicates with an external device and a second communication unit that wirelessly communicates with a base station controls the first communication unit to send data received by the second communication unit to the external device or controls the second communication unit to send data received by the first communication unit to the base station,
the method comprising a step of controlling the second communication unit to send information relating to resource assignment corresponding to a data transfer rate of the first communication unit to the base station.
